(19) United States
(12) Patent Application Publication
(10) Pub. No.: US 2008/0163731 A1
(43) Pub. Date: Jul. 10, 2008

(54) TUBE PURGING INSTRUMENT

(76) Inventor: Howell G. Lewis, Bristol, FL (US)

Correspondence Address: ROETZEL & ANDRESS, 1375 EAST 9TH STREET, CLEVELAND, OH, 44114, US

(21) Appl. No.: 11/970,968

(22) Filed: Jan. 8, 2008

Related U.S. Application Data
(60) Provisional application No. 60/879,019, filed on Jan. 8, 2007.

(51) Int. Cl. B25B 33/00; B25B 9/04

(52) U.S. Cl. 81/486

(57) ABSTRACT

A tube purging instrument device has cooperating rollers which can be compressed and/or clamped together upon a flexible tube to compress the tube partially or completely between the rollers and which can then be rolled together along the length of the tube in order to advance the contents of the tube in the direction of movement of the rollers. The rollers are preferably equipped with flanges or rims which fit over an outer diameter of a tube to maintain registration of the rollers upon tube as the rollers travel in counter-rotation along a length of the tube.

### RELATED APPLICATIONS

This application is a conversion of U.S. provisional application No. 60/879,019, filed Jan. 8, 2007

### FIELD OF THE INVENTION

The present invention is in the general field of tools, instruments and devices, including hand tools and instruments and more particularly hand tools and instruments and devices which can be used in connection with fluid and material handling equipment, and with medical equipment and procedures and devices. BACKGROUND OF THE INVENTION

In many different types of medical procedures drainage tubing is used to convey body fluids away from the body and to a receptacle. Common examples are open and invasive surgical procedures within major body cavities, such as for example the peritoneum, including all types of thoracic and vascular surgical procedures, following which continuous drainage of fluids, such as saline and lymphatic fluids, is required for normal healing processes. In some procedures such as cardiac bypass there may be multiple drainage sites at which receiving ends of drainage tubes are positioned. Each drainage tube must be kept sterile, and establish a positive flow direction away from the body, by gravity or siphon, and be continuously monitored for efficacy throughout the healing process. One common product or device which is used for surgical drainage is the Jackson-Pratt or JP drain, which is a suction and drainage device used to pull excess fluid from the body. The JP drain consists of a flexible plastic bulb which is connected to a flexible drainage tube which extends from the body. Patients or caretakers can milk or strip the drains by compressing the tube near the point of exit from the body and sliding the compression point down the length of the tube to the drainage receptacle or bulb. This task cannot be accomplished by patients who are unconscious or disabled, and must therefore be performed by a nurse or other caregiver. Purging, stripping or “milking” drainage tube contents is commonly done manually, by holding one end of the tube with one hand distant from the receptacle, and sliding compressed fingers of the other hand down the length of the tube toward the receptacle. This two-handed act is awkward, unsanitary and not practical or easy to be performed by the patient. There is also risk of dislodging the drainage tube from the exit at the body and disrupting surrounding sutures. Although principally described in the context of medical application and use, the device and instrument of the disclosure and the invention is equally applicable and effective in any environment wherein the purging or movement of tube contents is required, including without limitation veterinary medicine, laboratory experiments and operations, commercial and research chemical or physical operations, and any tube transfer or conveyance of liquid, flowable solids or gases.

### SUMMARY OF THE INVENTION

The disclosure and invention provides a new and improved device and instrument and method for purging or stripping or voiding the contents of a flexible tube. In a representative embodiment of the principles and concepts of the disclosure, a tube purging instrument has first and second rollers, each roller mounted for rotation upon a spindle, each spindle extending from an arm, each arm being movable with respect to the other arm in order to change relative positions of the rollers, the rollers being positionable by movement of the arms so that the spindles are generally parallel and rolling surfaces of the rollers are closely adjacent whereby a segment of a tube positioned between the rolling surfaces of the rollers is compressed and counter-rotation of the rollers against the tube is caused by movement of the arms in a path generally parallel to a length of the tube.

These and other embodiments and aspects of the disclosure and exemplary embodiments are further described herein with reference to the accompanying drawing Figures.

### DESCRIPTION OF THE DRAWINGS

FIG. 1 is a perspective view of a tube purging instrument of the disclosure in a representative mode of use;

FIG. 2 is a perspective view of a tube purging instrument of the disclosure in a representative mode of use;

FIG. 3 is a profile view of a tube purging instrument of the disclosure;

FIG. 4 is a perspective view of a tube purging instrument of the disclosure;

FIG. 5 is a profile view of a tube purging instrument of the disclosure;

FIG. 6 is a profile view of a tube purging instrument of the disclosure, and

FIG. 7 is a profile view of a tube purging instrument of the disclosure.

### DETAILED DESCRIPTION OF PREFERRED AND ALTERNATE EMBODIMENTS

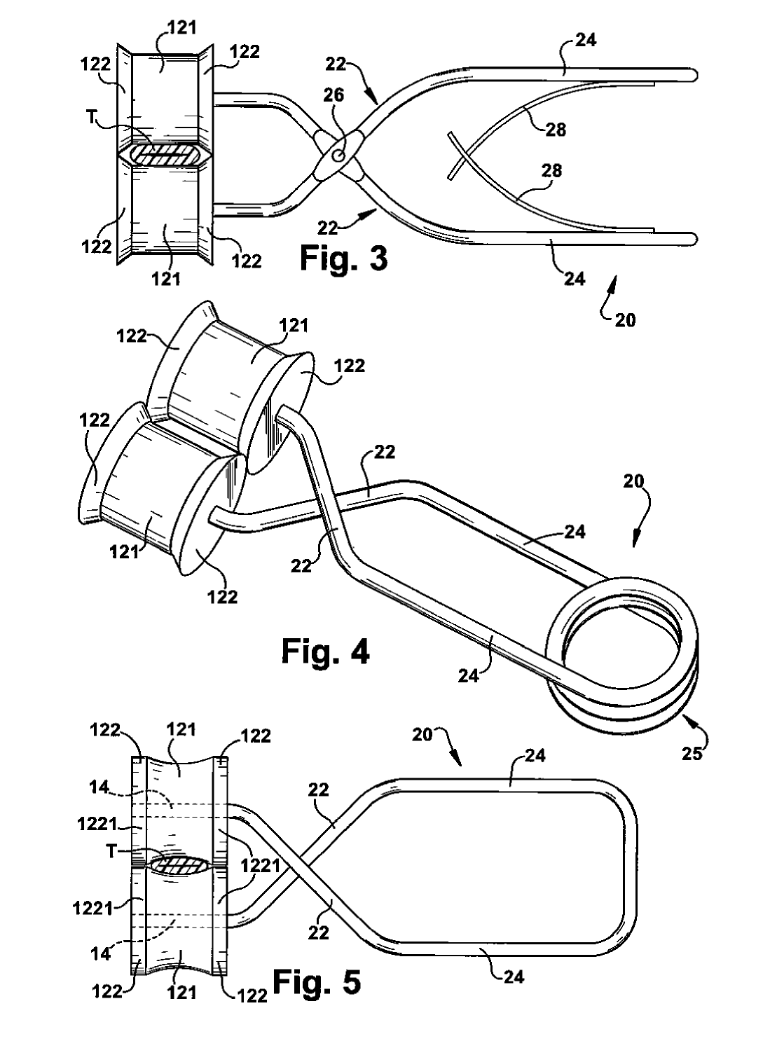

A tube purging instrument or device, shown in the Figures and indicated in its entirety at 10, is in the general form of a single hand-held and operated instrument, by, for example, a right or left hand, for use in connection with one or more tubes which are flexible to a degree which allows for transverse compression across a width of the tube(s) for partial or total occlusion of the tubal passage. An exemplary application and use of the tube purging instrument 10 is in connection with tubing used in medical application and procedures and drainage, such as the tubes of Jackson-Pratt drains, for transport of fluid and viscous material to or from the body. A common example is surgical drainage from the situs or cavity of surgical activity, where there has been invasion and insult to tissue or removal of tissue or organs. In order to quickly and efficiently purge a tube of contents in a sterile and safe manner, the device 10 is equipped with a pair of cooperating rollers 12 which are mounted for free rotation upon axles or spindles 14 which extend from a hand grip structure 20 as further described. The rollers 12 are configured to fit or extend over a tube of conventional size, such as according to the exterior outer diameter of the tube T. Each roller 12 has a rolling surface 121 which has a width which is preferably approximately equal to an outer diameter or width of tube T. Each roller 12, or optionally only one of the rollers 12, is preferably equipped with flanges or rims 122 at opposite axial ends of the roller 12 which straddle the tube T when the rolling surfaces 121 are aligned with the tube T, as shown in FIGS. 3, 5 and 6. With the rollers 12 in the fully clamped or compressed position, the opposing rims 122 are preferably in rolling contact or near contact bilaterally with respect to the tube T. This maintains the rollers 12, and particularly the rolling surfaces 121 of the rollers 12 in alignment with the tube T, so that the rollers 12 can be quickly advanced by rolling along the length of the tube T without concern for rolling off of the tube T. The rims 122 maintain the rolling surfaces 121 in linear alignment and registration with the tube T. As shown in the Figures, the rolling surfaces 121 of the rollers 12 may be cylindrical with a straight edge profile, or tapered as shown in FIG. 5 such as convex to conform to the exterior of a compressed cylindrical tube. The rims 122 may be tapered from the rolling surface 121 (FIGS. 2-4), or truncated (FIGS. 5-7) to have their own bearing surfaces 1221 which counter-rotate with the opposing surface 1221.

Each roller 12 is mounted upon an axle or spindle 14 which extends from a hand grip structure 20, which has cooperating and opposing arms 22, each with an associated handle or gripping bar 24. The arms 22 cross at some point along the length of the structure 20 so that the action of squeezing the handles or gripping bars 24 together causes the rollers 12 to diverge to allow for positioning of the tube T between the rollers 12 and to be placed into contact with the rolling surfaces 121 of the rollers 12 to fully or substantially compress tube T, as shown for example in FIGS. 3, 5 and 6.

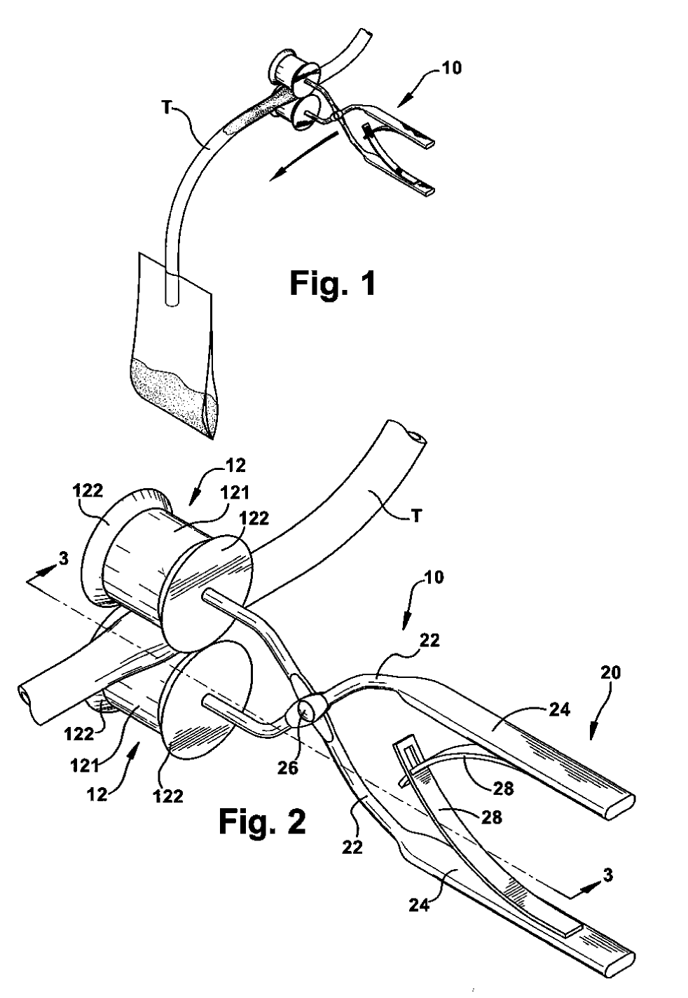

FIGS. 1-3 and 6 illustrate a scissors type embodiment of the hand grip structure 20 wherein the arms 22 are joined together by a pivot 26 about which and by which the described divergence and convergence of the rollers 12 occurs. The arms 22 can be biased toward the operative or compressed position with the rollers 12 (and axles 14) generally parallel, by the provision of a spring or spring system, such as the cooperating leaf springs 28 shown between the handles 24 in FIGS. 1-3, or a coil spring 25 as shown in FIG. 4, or by the inherent spring properties of the material such as spring steel as may be used in the construction of a wire-form hand grip structure 20 as shown in FIG. 5.

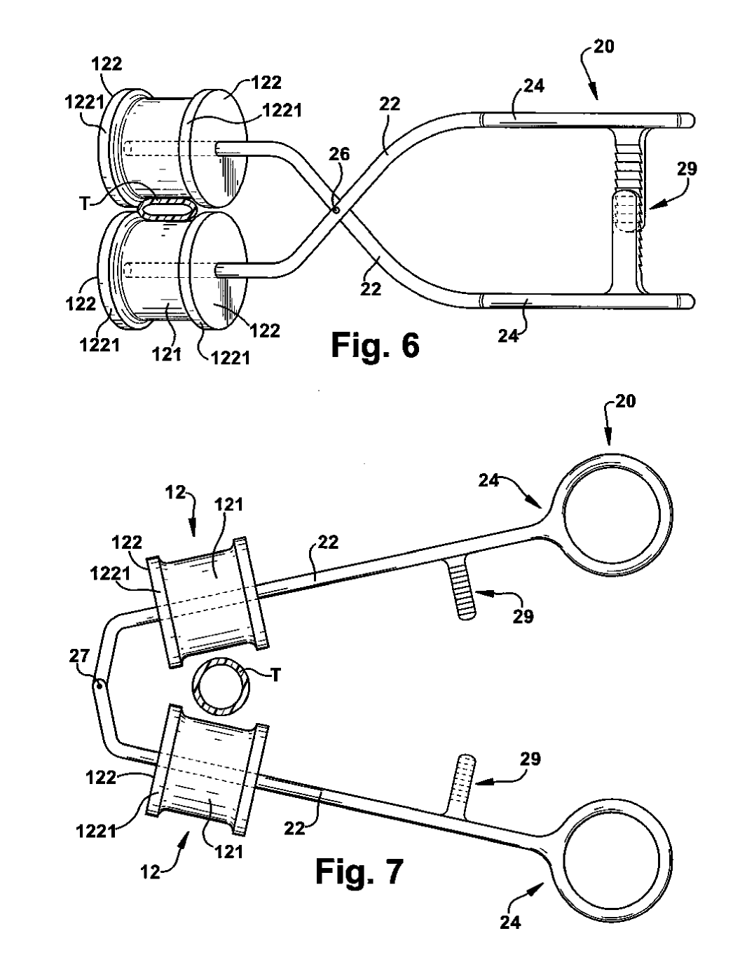

FIG. 6 illustrates an alternate embodiment of a hand grip structure 20 which also incorporated a pivot 26 connection between cooperating arms 22, and a clamp 29 located between the handles 24, which when engaged holds the rollers 12 in the tube-compressing position. The clamp 29 can be configured with multiple position settings, by the numerous cooperating and engaging teeth 291, to adjust the degree of compression placed upon the tube T by the rollers 12.

FIG. 7 illustrates an alternate embodiment of a hand grip structure 20 wherein the cooperating arms 22 are hinged or pivoted at a pivot 27 which is located at a distal end of the arms 22 and distant from handles 24 with the rollers 12 located intermediate the pivot 27 and handles 24. The clamping and compressive action of the rollers 12 upon tube T is applied by manipulation of the handles 24, and held in such position by a similar clamp 29 as described in connection with the embodiment of FIG. 6.

The disclosure and invention in one or more of the various representative forms thus provides a useful instrument and device for rapid, sterile and efficient purging, stripping or milking of contents of flexible tubing, by the described application and use to any length of tubing in any application. The disclosure and invention is not limited to any particular dimensions or configurations, but for use with common tube sizes the instrument or device may be ergonomically configured and dimensioned for hand-held operation and use and convenient portage and storage.

1. A tube purging instrument comprising:
first and second rollers, each roller mounted for rotation upon a spindle, each spindle extending from all arm, each arm being movable with respect to the other arm in order to change relative positions of the rollers,
the rollers being positionable by movement of the arms so that the spindles are generally parallel and rolling surfaces of the rollers are closely adjacent whereby a segment of a tube positioned between the rolling surfaces of the rollers is compressed and counter-rotation of the rollers against the tube is caused by movement of the arms in a path generally parallel to a length of the tube.

2. The tube purging instrument of claim 1 further comprising a handle connected to or incorporated with each of the arms.

3. The tube purging instrument of claim 1 wherein the arms are connected together by a hinge or pivot.

4. The tube purging instrument of claim 1 wherein the arms are spring-biased toward a position where the rollers are proximate and the spindles on which the rollers are mounted are generally parallel.

5. The tube purging instrument of claim 4 wherein the arms are spring-baised toward a position where the rollers are proximate and the spindles on which the rollers are mounted are generally parallel by a leaf spring located between the arms.

6. The tube purging instrument of claim 4 wherein the arms are spring-baised toward a position where the rollers are proximate and the spindles on which the rollers are mounted are generally parallel by a coil spring located between the arms.

7. The tube purging instrument of claim 1 wherein each of the rollers further comprises a pair of rims, each rim located at an end of the respective roller and extending radially beyond the rolling surface of the roller.

8. The tube purging instrument of claim 7 wherein the rims further comprise a bearing surface configured for contact with a bearing surface of an opposing rim of an opposing roller when brought into contact.

9. The tube purging instrument of claim 1 wherein the arms are connected together by a pivot and a spring.

10. The tube purging instrument of claim 1 further comprising a locking device between the arms operative to lock the arms in a position wherein the rollers are proximate and the spindles on which the rollers are mounted are generally parallel.

11. The tube purging instrument of claim 1 wherein the rolling surfaces of the rollers have a generally flat profile.

12. The tube purging instrument of claim 1 wherein the rolling surfaces of the rollers have a generally curved profile.

13. The tube purging instrument of claim 1 wherein the rollers are configured to substantially fully compress a tube positioned between the rollers when the rollers are moved together by the arms.

14. A tube purging instrument comprising;
a pair of rollers, each roller mounted to a hand grip structure, the hand grip structure comprising a pair of arms, each arm having a spindle upon which one of the rollers is mounted for rotation, the arms being connected together for relative movement and relative movement of the rollers between a spaced-apart position and a proximate position wherein the rollers are generally axially aligned and the spindles are generally parallel, and wherein rolling surfaces of the rollers are opposed and closely spaced apart so as to be able to compress a segment of a tube positioned between the rollers.

15. The tube purging instrument of claim 14 wherein the arms of the hand grip structure are connected together by a pivot.

16. The tube purging instrument of claim 14 wherein the hand grip structure further comprises a handle associated with each of the arms.

17. The tube purging instrument of claim 15 wherein the arms are configured to cross at the pivot.

18. The tube purging instrument of claim 14 wherein the rolling surfaces of the rollers are generally flat.

19. The tube purging instrument of claim 14 wherein the rolling surfaces of the rollers are generally curved.

20. The tube purging instrument of claim 14 wherein each of the rollers further comprise a rim at opposite ends of the roller and which project radially beyond the rolling surface of the roller.

21. The tube purging instrument of claim 20 wherein each rim further comprises a bearing surface configured for rolling contact with a bearing surface of an opposing rim of an opposing roller when the rollers are in the proximate position with the rollers generally axially aligned and the spindles generally parallel.

22. The tube purging instrument of claim 20 wherein the rims are generally tapered.

23. The tube purging instrument of claim 20 wherein the rims are generally cylindrical.

24. The tube purging instrument of claim 14 wherein the rolling surfaces of the rollers are configured for rolling contact with a flexible tube.

25. The tube purging instrument of claim 14 wherein the arms of the hand grip structure are biased to a position wherein the rollers are proximate and the spindles are generally parallel.

26. The tube purging instrument of claim 14 wherein the rolling surfaces of the rollers are spaced apart when the rollers are in the proximate position with the rollers generally axially aligned and the spindles generally parallel.

27. A tube purging instrument comprising:
first and second rollers, each roller mounted for rotation upon a spindle, each spindle extending from an arm, each arm being movable with respect to the other arm in order to change relative positions of the rollers;
the rollers being positionable by movement of the arms so that the spindles are generally parallel and rolling surfaces of the rollers are closely adjacent whereby a segment of a tube positioned between the rolling surfaces of the rollers is compressed and counter-rotation of the rollers against the tube is caused by movement of the arms in a path generally parallel to a length of the tube;
wherein each of the rollers further comprises a pair of rims, each rim located at an end of the respective roller and extending radially beyond the rolling surface of the roller, wherein each of the rims further comprises a bearing surface configured for contact with a bearing surface of an opposing rim of an opposing roller when brought into contact, and wherein the rolling surfaces of the opposing rollers are spaced apart when the bearing surfaces of the rims are in contact.
